(19) United States
(12) Patent Application Publication
(10) Pub. No.: US 2014/0218660 A1
(43) Pub. Date: Aug. 7, 2014

(54) DUAL DISPLAY MODULE AND METHOD FOR ENHANCING DISPLAY BRIGHTNESS

(71) Applicant: HTC CORPORATION, Taoyuan County (TW)

(72) Inventors: Weng-Chang Shen, Taoyuan County (TW); Hsu-Hsiang Tseng, Taoyuan County (TW)

(73) Assignee: HTC CORPORATION, Taoyuan County (TW)

(21) Appl. No.: 13/762,322

(22) Filed: Feb. 7, 2013

(51) Int. Cl. F21V 8/00

(52) U.S. Cl. CPC G02B 6/0033
USPC 349/62; 362/613; 445/24

(57) ABSTRACT

A dual display module including a transmissive display panel, at least one transparent light guide device, and at least one light source is provided. The transmissive display panel has a first display surface and a second display surface opposite to the first display surface. The first display surface is disposed between the transparent light guide device and the second display surface. The light source is disposed beside the transparent light guide device and is capable of emitting a light beam. The transparent light guide device guides the light beam to enter the transmissive display panel through the first display surface. After the light beam entered the transmissive display panel, the light beam exits the transmissive display panel from the second display surface. A method for enhancing display brightness is also provided.

### BACKGROUND OF THE INVENTION

1. Field of the Invention

The invention relates generally to a display module and a method for enhancing display effects, and more particularly to a dual display module and a method for enhancing display brightness.

2. Description of Related Art

A transparent display refers to a display having a certain degree of transmittance, in which the background behind the panel can be clearly displayed. Transparent displays are suitable for applications such as building windows, automobile windows, and shop windows, for example. Besides the basic transparent display function, the transparent display has the potential to be developed into the information display of the future, and so the market is following closely.

When the transparent display is applied as a building window, for example, the ambient light beams are used as the backlight source, allowing the user to see the images shown by the display. However, the intensity of the ambient beams are not controllable by the user. If the external light is insufficient and the brightness of the display too low, the user cannot clearly see the images shown by the display. In other words, the conventional transparent displays (i.e. dual displays) have the issue of insufficient brightness.

### SUMMARY OF THE INVENTION

The invention provides a dual display module capable of mitigating the issue of insufficient display brightness of the conventional dual display modules.

The invention provides a method for enhancing display brightness capable of effectively increasing the display brightness.

The invention provides a dual display module, including a transmissive display panel, at least one transparent light guide device, and at least one light source. The transmissive display panel has a first display surface and a second display surface opposite to the first display surface. The first display surface is disposed between the transparent light guide device and the second display surface. The light source is disposed besides the transparent light guide device, and the light source is capable of emitting a light beam. The transparent light guide device guides the light beam to enter the transmissive display panel through the first display surface. After the light beam entered the transmissive display panel, the light beam exits the transmissive display panel from the second display surface.

According to an embodiment of the invention, the transparent light guide device comprises a transparent light guide film.

According to an embodiment of the invention, the transparent light guide device is directly adhered on the first display surface.

According to an embodiment of the invention, a light transmittance of the transparent light guide device is substantially greater than or equal to 98%.

According to an embodiment of the invention, the dual display module may further include a holding structure. The holding structure connects the transparent light guide device to the transmissive display panel.

According to an embodiment of the invention, the light source is disposed in the holding structure.

According to an embodiment of the invention, the transparent light guide device includes a plurality of optical microstructures.

According to an embodiment of the invention, a cross-sectional shape of the optical microstructures cut by a reference plane includes a triangular shape, a circular shape, or a polygonal shape, in which the reference plane is perpendicular to the first display surface.

According to an embodiment of the invention, the at least one light source includes two light sources. The two light sources are respectively disposed on two opposite sides of the transparent light guide device.

According to an embodiment of the invention, the at least one transparent light guide device includes two transparent light guide devices. The transparent light guide devices are respectively disposed on the first display surface and the second display surface.

According to an embodiment of the invention, the transmissive display panel includes a liquid crystal display panel or an organic electro-luminescence display panel.

The invention provides a method for enhancing display brightness, including the following steps. A transmissive display panel having a first display surface and a second display surface opposite to the first display surface is provided. At least one transparent light guide element is provided, and the first display surface is disposed between the transparent light guide element and the second display surface. At least one light beam is provided, and the at least one light beam is guided by the transparent light guide device to enter the transmissive display panel through the first display surface, and to exit the transmissive display panel from the second display surface, so as to enhance a display brightness.

According to an embodiment of the invention, the transparent light guide device includes a transparent light guide film.

According to an embodiment of the invention, the step of disposing the first display surface between the transparent light guide device and the second display surface includes directly adhering the transparent light guide film on the first display surface.

According to an embodiment of the invention, the method for enhancing display brightness further includes providing a holding structure connecting the transparent light guide device to the transmissive display panel.

According to an embodiment of the invention, the step of providing the at least one light beam includes using at least one light source to provide the at least one light beam, and respectively disposing the at least one light source on a side of the transparent light guide device.

According to an embodiment of the invention, the step of providing the at least one transparent light guide device includes providing two transparent light guide devices, and respectively disposing the transparent light guide devices on the first display surface and the second display surface.

In summary, by utilizing the transparent light guide device and the light source, the dual display module and the method for enhancing display brightness according to embodiments of the invention can further enhance the brightness of the dual display module, and thereby mitigate the issue of insufficient display brightness of the conventional dual display modules.

Several exemplary embodiments accompanied with figures are described in detail below to further describe the invention in details.

### BRIEF DESCRIPTION OF THE DRAWINGS

The accompanying drawings are included to provide a further understanding of the invention, and are incorporated in and constitute a part of this specification. The drawings illustrate exemplary embodiments of the invention and, together with the description, serve to explain the principles of the invention.

FIG. 1 is a schematic cross-sectional view of a dual display module according to a first embodiment of the invention.

FIG. 2 is a schematic cross-sectional view of a dual display module according to a second embodiment of the invention.

FIG. 3 is a flow chart of a method for enhancing display brightness according to an embodiment of the invention.

### DETAILED DESCRIPTION OF DISCLOSED EXEMPLARY EMBODIMENTS

### First Embodiment

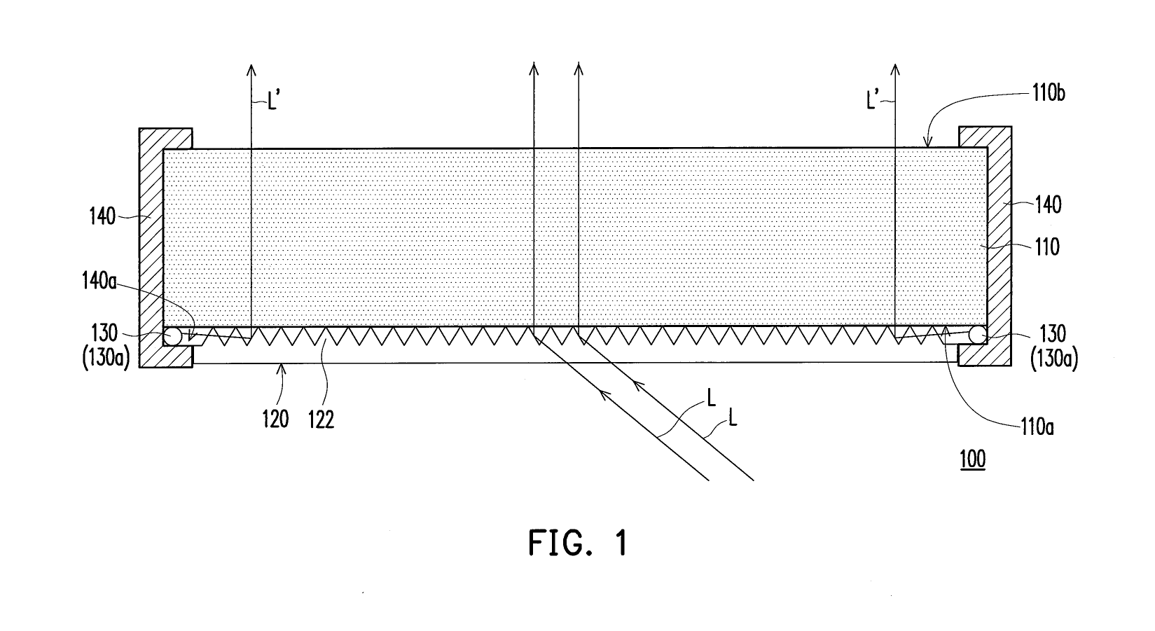

FIG. 1 is a schematic cross-sectional view of a dual display module according to a first embodiment of the invention. With reference to FIG. 1, a dual display module 100 of the present embodiment includes a transmissive display panel 110 and at least one transparent light guide device 120. The transmissive display panel 110 has a first display surface 110a and a second display surface 110b opposite to the first display surface 110a. The first display surface 110a is disposed between the transparent light guide device 120 and the second display surface 110b. In the present embodiment, the transmissive display panel 110 may be a non-self-illuminating display panel or a self-illuminating display panel, such as a liquid crystal display panel or an organic electro-luminescence display panel.

It should be noted that, the dual display module 100 of the present embodiment can effectively guide the ambient beams L into the transmissive display panel 110 by using the transparent light guide device 120, and further concentrate the transmission directions of the ambient beams L toward a direction perpendicular to the second display surface 110b (or the first display surface 110a). Accordingly, the brightness of the dual display module 100 can be enhanced at least on a single surface, and the issue of insufficient brightness for the conventional dual display modules can be mitigated.

Furthermore, the dual display module 100 of the present embodiment may selectively include at least one light source 130. In the present embodiment, the at least one light source 130 may be two light sources 130a and 130b. The light sources 130a and 130b may be respectively disposed on two opposite sides of the transparent light guide device 120, and the light sources 130a and 130b are capable of emitting the light beams U. The transparent light guide device 120 guides the light beams to enter the transmissive display panel 110 through the first display surface 110a. After the light beams L′ entered the transmissive display panel 110, the light beams L′ can exit the transmissive display panel 110 from the second display surface 110b.

In other words, by using the transparent light guide device 120 and the light source 130, the brightness of the dual display module 100 can be further increased, so the display effect of the dual display module 100 is preferable. In specifics, the brightness of the dual display module 100 of the present embodiment is more than 1.85 times the brightness of compared dual display modules. A difference between the compared dual display modules and the dual display module 100 of the present embodiment is that, the compared dual display modules do not include the transparent light guide device 120 and the light source 130.

Moreover, when the intensity of the ambient light beams L is insufficient, such as on a cloudy day or in a darkened room, for example, the light source 130 can provide the extra light beams so that the dual display module 100 can maintain the high brightness. Accordingly, even when the external environment changes, the user can still view images of preferable display effect through the dual display module 100 of the present embodiment. In the present embodiment, the light source 130 may be a light emitting diode, for example. However, the invention is not limited thereto. In other embodiments, the light source 130 may also be a cold cathode fluorescent lamp (CCFL) or other suitable light emitting devices.

Physical properties of lightness/thinness and high light transmittance are preferable for the transparent light guide device 120 of the present embodiment. For example, the transparent light guide device 120 of the present embodiment may be a transparent light guide film having a thickness on the order of microns, and the light transmittance of the transparent light guide film may be substantially greater than or equal to 98%. The transparent light guide film can be directly adhered on the first display surface 110a, such that the thickness of the dual display module 100 is not drastically increased while still maintaining high brightness. In other words, the dual display module 100 of the present embodiment has both the advantages of high brightness and thinness. However, the invention is not limited thereto, and the transparent light guide device 120 of the present embodiment may also be a light guide plate (LBP) of a higher rigidity, which can be connected to the transmissive display panel 110 by a holding structure 140. Moreover, the light source 130 of the present embodiment can be disposed in an accommodating space 140a defined by the holding structure 140, the transmissive display panel 110, and the transparent light guide device 120.

Furthermore, the transparent light guide device 120 of the present embodiment can further include a plurality of optical microstructures 122. The optical microstructures 122 can uniformly transmit the light beams L′ (or the ambient beams L) toward the second display surface 110b, and thereby enhance the uniformity and brightness of the dual display module 100 of the present embodiment. For example, the optical microstructures 122 of the present embodiment may be protruding strips having an extended direction parallel to the first display surface 110a. To be specific, a cross-sectional shape of the optical microstructures 122 cut by a reference plane include a triangular shape, a circular shape, or a polygonal shape, in which the reference plane (the paper plane of FIG. 1) is perpendicular to the first display surface 110a. However, the invention is not limited thereto, and the exterior shape and disposition of the optical microstructures 122 may be suitably designed according to an actual requirement.

### Second Embodiment

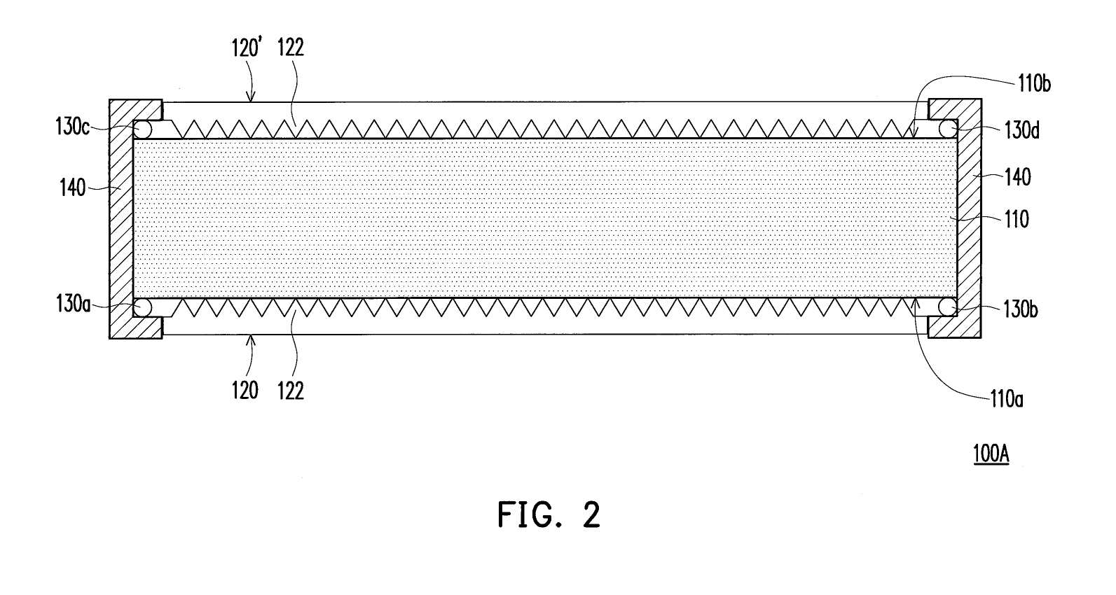

FIG. 2 is a schematic cross-sectional view of a dual display module according to a second embodiment of the invention. With reference to FIG. 2, a dual display module 100A of the present embodiment is similar to the dual display module 100 of the first embodiment, and therefore the same elements are represented by the same labels. A difference between the dual display module 100A of the present embodiment and the dual display module 100 of the first embodiment is that, the dual display module 100A of the present embodiment further includes a transparent light guide device 120′ and a plurality of light sources 130c and 130d. The difference is further elaborated in the description hereafter, while the similar parts are omitted.

The dual display module 100A of the present embodiment includes the transmissive display panel 110 having the first display surface 110a and the second display surface 110b, two transparent light guide devices 120 and 120′, and a plurality of light sources 130a, 130b, 130c, and 130d. The transparent light guide devices 120 and 120′ are respectively disposed on the first display surface 110a and the second display surface 110b. The light sources 130a and 130b are disposed on two opposite sides of the transparent light guide device 120, and the light sources 130a and 130b are capable of emitting the light beams L1. The light sources 130c and 130d are disposed on two opposite sides of the transparent light guide device 120′, and the light sources 130c and 130d are capable of emitting the light beams L2. The transparent light guide device 120 guides the light beams L1 to enter the transmissive display panel 110 from the first display surface 110a, and after the light beams L1 entered the transmissive display panel 110, the light beams L1 exit the transmissive display panel 110 from the second display surface 110b. The transparent light guide device 120 guides the light beams L2 to enter the transmissive display panel 110 from the second display surface 110b, and after the light beams L2 entered the transmissive display panel 110, the light beams L2 exit the transmissive display panel 110 from the first display surface 110a.

In other words, the dual display module 100A of the present embodiment can increase the brightness of both surfaces of the dual display module 100A. Accordingly, two users respectively located beside the first display surface 110a and the second display surface 110b can both view images of preferable display effect.

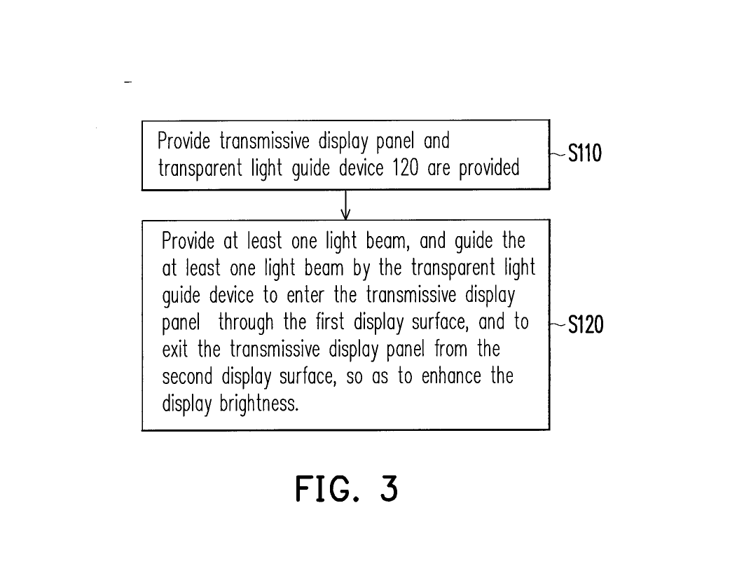

FIG. 3 is a flow chart of a method for enhancing display brightness according to an embodiment of the invention. With reference to FIGS. 1 and 3, the method for enhancing display brightness according to the present embodiment can be performed by the afore-described dual display modules 100 or 100A, and the dual display module 100 is used in the description hereafter as an illustrative example. The method for enhancing display brightness according to the present embodiment includes the following steps. First, Step S110 is performed, in which the transmissive display panel 110 and at least one transparent light guide device 120 are provided (if the method is performed using the dual display module 100 of FIG. 1, then one transparent light guide device 120 is provided; if the method is performed using the dual display module 100A of FIG. 2, then the transparent light guide devices 120 and 120′ are provided). The transmissive display panel 110 has a first display surface 110a and a second display surface 110b opposite to the first display surface 110a. Moreover, in Step S110, the first display surface 110a is disposed between the transparent light guide device 120 and the second display surface 110b.

Thereafter, Step S120 is performed, in which at least one light beam (at least one of light beams L′ and ambient light beams L) is provided, and the at least one light beam is guided by the transparent light guide device 120 to enter the transmissive display panel 110 through the first display surface 110a, and to exit the transmissive display panel 110 from the second display surface 110b, so as to enhance the display brightness.

Other details of the method for enhancing display brightness of the present embodiment or the method using the dual display module 100A of FIG. 2 can known with reference to the afore-described embodiments of the dual display modules 100 and 100A, and therefore further elaboration thereof is omitted.

By using the transparent light guide device to guide light beams, the method for enhancing display brightness of the present embodiment can enhance display brightness and thereby the display effect.

In view of the foregoing, by utilizing the transparent light guide device and the light source, the dual display module and the method for enhancing display brightness according to embodiments of the invention can further enhance the brightness of the dual display module, and thereby provide images of preferable display effect. Moreover, when the external environment changes (e.g. on a cloudy day or in a darkened room), the dual display module according to an embodiment of the invention can still maintain the high brightness by using the transparent light guide device and the light source.

It will be apparent to those skilled in the art that various modifications and variations can be made to the structure of the disclosure without departing from the scope or spirit of the invention. In view of the foregoing, it is intended that the disclosure cover modifications and variations of this invention provided they fall within the scope of the following claims and their equivalents.

What is claimed is:

1. A dual display module, comprising:
a transmissive display panel having a first display surface and a second display surface opposite to the first display surface;
at least one transparent light guide device, the first display surface being disposed between the transparent light guide device and the second display surface; and
at least one light source disposed beside the transparent light guide device, the at least one light source being capable of emitting a light beam, wherein the transparent light guide device guides the light beam to enter the transmissive display panel through the first display surface, and after the light beam entered the transmissive display panel, the light beam exits the transmissive display panel from the second display surface.

2. The dual display module according to claim 1, wherein the transparent light guide device comprises a transparent light guide film.

3. The dual display module according to claim 2, wherein the transparent light guide device is directly adhered on the first display surface.

4. The dual display module according to claim 1, wherein a light transmittance of the transparent light guide device is substantially greater than or equal to 98%.

5. The dual display module according to claim 1, further comprising a holding structure connecting the transparent light guide device to the transmissive display panel.

6. The dual display module according to claim 5, wherein the light source is disposed in the holding structure.

7. The dual display module according to claim 1, wherein the transparent light guide device has a plurality of optical microstructures.

8. The dual display module according to claim 7, wherein a cross-sectional shape of the optical microstructures cut by a reference plane comprises a triangular shape, a circular shape, or a polygonal shape, wherein the reference plane is perpendicular to the first display surface.

9. The dual display module according to claim 1, wherein the at least one light source comprises two light sources, and the light sources are respectively disposed on two opposite sides of the transparent light guide device.

10. The dual display module according to claim 1, wherein the at least one transparent light guide device comprises two transparent light guide devices, and the transparent light guide devices are respectively disposed on the first display surface and the second display surface.

11. The dual display module according to claim 1, wherein the transmissive display panel comprises a liquid crystal display panel or an organic electro-luminescence display panel.

12. A method for enhancing display brightness, comprising:
providing a transmissive display panel having a first display surface and a second display surface opposite to the first display surface;
providing at least one transparent light guide device, and disposing the first display surface between the transparent light guide device and the second display surface;
providing at least one light beam and guiding the at least one light beam by the transparent light guide device to enter the transmissive display panel through the first display surface, and to exit the transmissive display panel from the second display surface, so as to enhance a display brightness.

13. The method for enhancing display brightness according to claim 12, wherein the transparent light guide device comprises a transparent light guide film.

14. The method for enhancing display brightness according to claim 13, wherein the step of disposing the first display surface between the transparent light guide device and the second display surface comprises:
directly adhering the transparent light guide film on the first display surface.

15. The method for enhancing display brightness according to claim 12, further comprising:
providing a holding structure, and connecting the transparent light guide device to the transmissive display panel by the holding structure.

16. The method for enhancing display brightness according to claim 12, wherein the step of providing the at least one light beam comprises:
using at least one light source to provide the at least one light beam; and
respectively disposing the at least one light source on a side of the transparent light guide device.

17. The method for enhancing display brightness according to claim 12, wherein the step of providing the at least one transparent light guide device comprises:
providing two transparent light guide devices, and respectively disposing the transparent light guide devices on the first display surface and the second display surface.
